(19) United States
(12) Patent Application Publication
(10) Pub. No.: US 2009/0091100 A1
(43) Pub. Date: Apr. 9, 2009

(54) Bicycle tow device for skater

(76) Inventor: Rick D. Barraza, Hermosa Beach, CA (US)

Correspondence Address: LAUSON & TARVER LLP, 880 APOLLO STREET, SUITE 301, EL SEGUNDO, CA, 90245, US

(21) Appl. No.: 12/156,193

(22) Filed: May 30, 2008

Related U.S. Application Data
(60) Provisional application No. 60/977,784, filed on Oct. 5, 2007.

(51) Int. Cl. B62K 27/12

(52) U.S. Cl. 280/292

(57) ABSTRACT

A device for safely towing a skater behind a bicycle includes a towline retractably coupled to a bicycle and having a handle at a free end being configured to permit the grasping thereto by no more than two fingers of a skater being towed therebehind. The handle provides a limited grip to the skater so that it is easily released from his or her hand in the case of a sudden change in motion. Additionally, the present towing device is retractable to prevent entanglement of the towline in the bicycle wheel. Advantageously, the device is preferably configured to facilitate pivoting for skating on both sides of the bicycle and angular adjustment for skaters of varying heights.

### RELATED APPLICATION DATA

This application claims the priority date of provisional application No. 60/977,784 filed on Oct. 5, 2007.

### BACKGROUND OF THE INVENTION

The present invention relates to a towing device for towing a skater behind a bicycle.

Often people within the same group will choose to utilize different modes of human powered transportation on a recreational or other outing. For example, one person may choose to ride a bicycle and another choose to travel on a skateboard, rollerblades, roller skates and the like. Due to the speed and mechanical advantage that bicycles have over skating, the skater may fall behind or tire before reaching the destination. Thus, it is natural that the cyclist tow the skater for all or portions of the journey.

U.S. Pat. No. 6,607,208 to Dartland shows a towing device for a skateboarder. It consists of a hollow horizontal pole that is connected to the bike by one end, a cord runs through the core of the pole, with a handle attached to the end of the cord. This device is designed so that the handle and cord are situated at least a couple of feet behind the rear wheel of the bicycle, to prevent entanglement. Although this device may operate well in terms of clearance under towing conditions, the long pole extending rearward is bulky and unwieldy when riding solo. Additionally, as can be seen in FIG. 9, the skateboarder holds onto the handle by fully grasping it with two hands. This type of handle can be a safety concern. People have a tendency to hold tight when grasping with all four fingers and thumb, and especially so when holding with two hands. On a crowded bike path or through tricky navigation, there are many times where there can be a sudden change in motion of the bicycle or skate, such as sudden stops or turns, or sand and cracks in the pavement. This change in motion can create a sudden jerk on the skateboarder. If the skateboarder is grasping with one full hand or both hands, the chances of that jerk causing a fall of the skateboarder or cyclist greatly increase. Therefore, even though the device prevents entanglement, it does not address the jerking safety concern.

Yet another device is shown in publication No. DE 20202683 assigned to Paulus. It is a retractable towing device that is attached to a first bicycle with a loop at the end of the cable for attachment and towing of a second bicycle. A quick release device is used to disengage the two bicycles when needed. A quick release device requires two parts, one at the end of the towline and one attached to the towed bicycle. Although this may work well for towing another bicycle, it would not seem to work well for towing a person who is skating. The quick release device is not suitable for manual holding of the free end of the towline because the skater would need to reach with one hand to activate the release mechanism. Since simply letting go of the handle in an emergency situation would be quicker than activating the quick release, but the device in this publication might not be ideal for towing a skater as the loop could encapsulate the skater's hand or fingers could make it difficult to separate from the device.

Accordingly, there has been a long-felt need in the art for a system for towing a skater behind a bicycle as safely as possible for both the bicyclist and the skater. This device should provide a system that quickly retracts the towline in a safe manner to prevent entanglement with the wheels and also provides a limited grip to the skater so that a sudden change in motion would jerk the handle from the skater's hand rather than causing the skater or cyclist to fall. Further, the device should be configured to adjust to changes in position of the handle based on movements of the skater and different height skaters while still functioning well.

### OBJECTS OF THE INVENTION

It is an object of the present invention to provide an improved towing device for towing a skater behind a bicycle;

It is a further object of the present invention to provide an improved towing device that provides a retractive bias on a towline to prevent slack and to fully retract the towline when released.

It is yet a further object of the present invention to provide an improved towing device that provides a limited grip to the skater to prevent continued grasping during a hazardous event; and

It is a further object of the present invention to provide an improved towing device that rotates relative to the bicycle in response to a skater's position.

It is a further object of the present invention to provide an improved towing device that offers angular adjustment for skaters of varying heights.

These and other objects and advantages of the present invention will become apparent upon reading the following detailed description and upon reference to the accompanying drawings.

### SUMMARY OF THE INVENTION

The present invention is directed to a novel towing device for safely towing a skater behind a bicycle. The novel towing device provides a limited grip to the skater so that the handle easily released from the skater's hand in the case of a sudden change in motion. Additionally, the present towing device is retractable to prevent entanglement of the towline. And preferably the towing device is configured to pivot to permit smooth extension and retraction.

The problem of safely towing a skater behind a bicycle is solved by a towline retractably coupled to a bicycle and having a handle at a free end being configured to permit the grasping thereto by no more than two fingers of a skater being towed therebehind. In a preferred embodiment of the present invention a device for towing a skater behind a bicycle is provided, including a spool coupled to the bicycle for automatically retracting a towline and a handle attached to the free end of the towline configured to permit the grasping by the skater by a maximum of two fingers.

It is important to note the limitation of the handle. It is configured to be held by no more than two fingers and optionally the thumb of one hand. The goal of this inventive design is to prevent the continued grasping of the handle in an emergency situation, such as a sudden change in motion or jerking. The skater, having a limited grip, is much less capable of holding the handle if it is suddenly jerked. The handle is involuntarily pulled from the hand with a minimal impulse. Since the handle can be gripped just enough to permit towing, but not enough to allow the skater to be pulled down and dragged in an emergency situation, the present device provides a simple and inventive safety handle that allows for the safe and fun towing of a skater.

The handle can be configured in a variety of shapes that limit the grip of the skater as specified. These handle shapes could include a T-shaped handle with each of the two extensions of the T being wide enough for one finger. Another possible handle shape could be spherical, again the diameter of the sphere being just large enough to permit the grasping by the average person by no more than two fingers and optionally the thumb. It is appreciated that numerous other handle shapes can be used with the present invention, so long as they provide a limited grip.

The spool preferably is the type that automatically retracts the towline on an internal reel, much like a conventional, automatic wind-up tape measure, although numerous retraction means can be used to pull in the towline, including a spring means, an elastic means or other suitable means of retraction. If the spool is retractably biased by a constant force spring, the spring constant is preferably set so that the towline is permitted to easily extend when a skater grasps the handle and so that the towline quickly retracts when the handle is released to prevent entanglement. Optionally, a grommet, compression spring or the like can be threaded on the towline to reduce the impact force of the handle on the spool.

Optionally, the spool can be mounted on a bracket. The bracket can be fastened to various appropriate parts of the bicycle, such as the seat post, the seat itself or the frame of the bicycle. Advantageously, the spool can be mounted to the bracket by a pivot to permit the free rotation of the spool relative to the bracket and bicycle. Another option might be the spool being built inside the bicycle seat post itself. Optional stops can be configured of the bracket or the spool to limit the rotation of the spool to a specified angle. Another optional embodiment can include an articulated bracket that permits the rotation of the spool relative to the bicycle. This can be achieved with a simple pivot dividing the bracket to with sufficient force permit the portion coupled with the spool to rotate relative to the opposing portion coupled to the bicycle. Yet anther option includes the mounting of the spool at an angle relative to the horizontal, for instance angled up, to permit the unhindered spooling and unspooling (retraction) of the towline.

Another optional embodiment includes bifurcating the towline to permit the attachment of two handles, one at each free end of the split towline. This permits the towing of two skaters at once. The spool can be configured to permit the retraction of the bifurcated towline by, for example, having a towline aperture large enough to permit the entrance of the two lines and their juncture. Optionally, towing two skaters can be achieved by mounting two spools on the bracket or the bicycle, each associated towline having a handle at the free end.

Additionally, another optional embodiment could include a reflective safety device. This reflective safety device could be a reflective sticker or decal adhered to the towing device, reflective paint applied to the towing device, or even a reflective lens mounted to the towing device. These reflective devices are to enhance visibility during reduced lighting conditions.

Also presented is a method for towing a skater behind a bicycle. The first step is to provide a spool coupled to a bicycle for the automatic retraction of a towline and a handle attached to the free end of the towline that is configured to permit the grasping by a skater. Further steps include grasping the handle with the skater's fingers, propelling the bicycle with a rider, and towing the skater behind the bicycle, and releasing the handle in the prevention of a hazardous occurrence. Optionally, the device provided can include a bifurcated towline that permits the attachment of two handles, allowing the further step of towing a second skater.

Besides the general utility of the device as described above in towing a slower-moving and perhaps tiring skater behind a faster and easier to propel bicycle over a long distance, the device is also useful in safely providing a fun activity along a beach (concrete) boardwalk and for use in skating shows and exhibitions.

### BRIEF DESCRIPTION OF THE SEVERAL VIEWS OF THE DRAWINGS

FIG. 1 is a side elevation view of a preferred embodiment of the present invention, showing the towing device attached to a seat post of a bicycle;

FIG. 2 is a side view of a second preferred embodiment of the present invention, showing the towing device attached to the seat of a bicycle;

FIG. 3 is a bottom plan view of the preferred embodiment of the present invention, showing the operation of the pivot and stops;

FIG. 4 is a side view of a skater being towed behind a bicycle grasping to the handle of the present towing device.

FIG. 5 is s top view of the handle of the present invention being grasped by two fingers and optionally the thumb of one hand.

FIG. 6 is a bottom view of the present invention with the towing line bifurcated for the towing of a second skater.

FIG. 7 is a side view of the present invention showing the bracket in the articulated embodiment.

FIG. 8 is a side view of the present invention showing a second spool.

### LISTING OF REFERENCE NUMERALS OF FIRST-PREFERRED EMBODIMENT

towing device 20

handle 21

spool 22

towline 24

free end 25

bracket 26

bicycle 28

cyclist 30

skater 32

skating device 34

pivot 36

stop 38

seat post 40

frame 42

seat 44

spring suspension 46

bracket 47

shock absorber 48

nut 49

junction 50

bifurcated towline 51

first branch 52

second branch 54

root 55

second spool 56

second towline 58

second handle 60

reflective means 62

right arm 64

left arm 66

hand 68

finger 70, 72

thumb 74

spherical handle 76

T-shaped handle 78

articulated bracket 80

pivot 82

### DESCRIPTION OF THE PREFERRED EMBODIMENTS

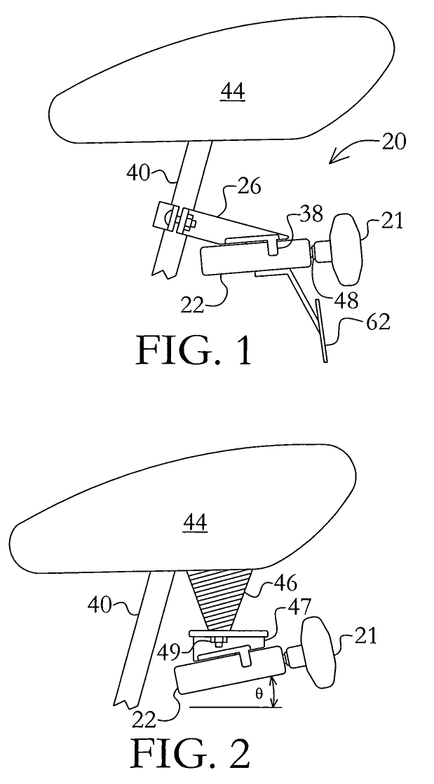

Looking first a FIG. 1, the towing device 20 of the present invention is shown mounted to the seat post 40 of a bicycle 28, underneath the seat 44. A bracket 26 serves as a mounting means for the device 20. In this example, a two part compression clamp is utilized to secure the towing device 20 to the bicycle 28, although other securing means are available. A spool 22 is pivotally coupled to the bracket 26. The spool 22 comprises a towline 24 (as seen in FIG. 4) that is retractably biased, so that the towline 24 will automatically pulled in within the spool 22 when unused. One type of retractable spool that can be purchased for use with this invention is the Gear Keeper made by Hammerhead Industries in Ventura, Calif. (www.gearkeeper.com). As one might surmise by the name, this device was being marketed for helping one retain his or her gear, and was never sold with a handle but rather with a clip for attaching to police/fire gear (microphones, flashlights, firearms) and sports gear (for fishing, scuba, hunting, etc.). Basically, a retractable lanyard can be chosen based on the desired retraction force needed. To reduce the impact of the retracting handle 21 as it strikes the spool 22, a shock absorber 48 is threaded on the towline 24. In displayed example, the shock absorber 48 is an elastomeric grommet or a similar elastic device that can cushion the impact force.

Now, turning to FIG. 2, an alternate bracket design can be seen, mounting instead to the spring suspension 46 of the bicycle 28. The bolts holding the spring suspension 46 in place can be removed by compressing the springs 46 and removing the nut 49. The bracket 47 can then be inserted over the threaded posts of the spring suspension 46 and the nuts 49 for each side can be threaded back on to secure the towing device 20 to the bicycle seat 44. Observe that the bracket 47 can be adjusted so that the angle θ (the angle relative to horizontal) is properly set for a given desired use. The advantage of angling the spool 22, up in this case, is to permit the towline 24 to be aligned with the spool 22 to allow unhindered retraction and extension. This is useful when the skater 32 holds the handle 21 of the towline 24 at a point above the mounting of the towing device 20.

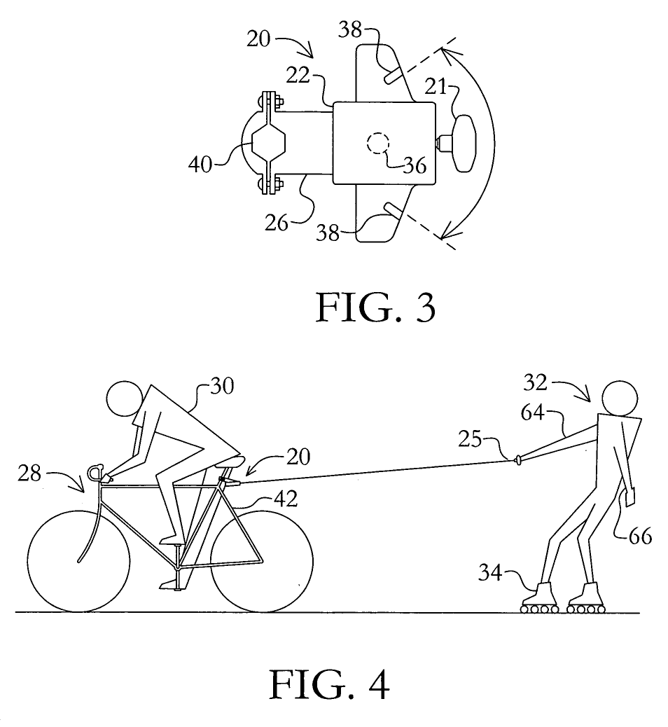

In FIG. 3 a plan view of the towing device 20 shown from below, mounted to a bicycle 28 with the seat post 40 indicated in cross-section. One stop 38 is located on each side of the spool 22. The spool 22 is coupled to the bracket 26 through a pivot 36, that permits the rotation of the spool 22 relative to the bracket 26. The pivot 36 can be a post inserted through a hole in the bracket 26 with a retainer ring securing the assembly. This is well known in the art and need not be shown or further described. The stops 38 can be molded as part of the bracket 26 by basically molding studs in the bracket or attaching them in a later process.

The rotation of the spool 22 is limited angularly as indicated by the curved arrows meeting the dashed lines, which correspond to the points at which sides of the spool 22 contact the stops 38 in either direction. The purpose of limiting the rotation of the spool 22 is to prevent the spool 22 from making a complete rotation and thereby tangling the towline 24 around the towing device 20, preventing proper operation and retraction of the towline 24. If the skater 32 were to release the handle 21 is this condition, the towline 24 could easily become entangled with the wheel of the bicycle 28, potentially causing an accident.

As can be seen in FIG. 4, a skater 32 is being towed behind a bicycle 28 holding the handle 21 attached to the free end 25 of the towline 24. A cyclist 30 is pedaling the bicycle 28. In this example, the towing device 20 is attached to the seat post 40, as shown in FIG. 1. It is important to note that the skater is grasping the handle 21 by just one hand on the right arm 64, with the left arm and hand 66 not grasping the handle 21. The handle 21 can be grasped with the right or left hand, the handle 21 being just large enough for the average person to grasp with just two fingers of one hand.

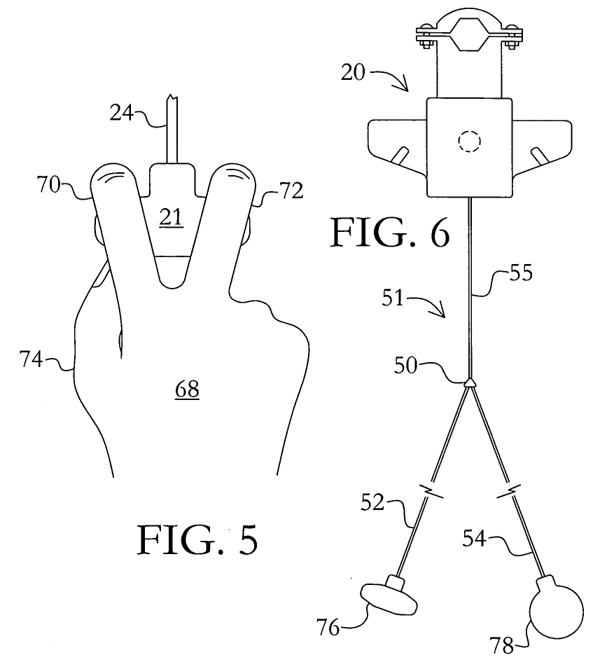

This grasping action can be seen more clearly when looking at FIG. 5. The handle 21 is being grasped by a skater's hand 68, with fingers 70 and 72 hooked around the handle 21. The thumb 74 can optionally provide an opposing grip, but is not necessary. Again, the handle 21 is designed to provide a limited grip, so that the handle 21 can either be easily manually released or involuntarily released during the occurrence of a potentially dangerous or unsafe condition. For example, the skater 32 or the cyclist 30 were to make a sudden change in motion, the handle 21 would be quickly jerked from the skater's hand 68 without pulling the skater 32 off balance or dragging the skater 32.

An alternate embodiment can be seen in FIG. 6, showing a bifurcated towline 51 with a single root 55 line leading to the spool 22 and at the junction 50 a first branch 52 splitting to the right and a second branch 54 splitting off to the left. This enables two skaters to be towed. To illustrate two of the many variations of the handle 21 of the present invention, a spherical handle 76 is attached to the second branch 54 and a T-shaped handle 78 is attached to the first branch 52.

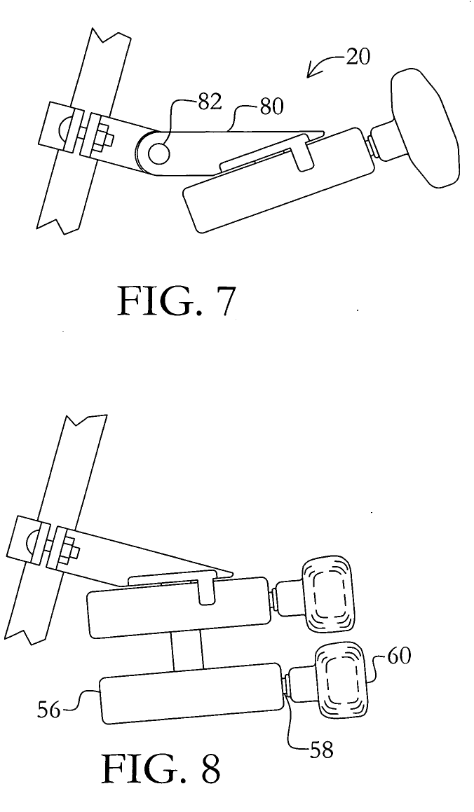

An articulated bracket 80 is shown in FIG. 7 as an alternate means to permit rotation of the spool 22 relative to the bicycle 28. The articulated bracket 80 is divided in two, with a pivot 82 enabling the rotation. Optionally, the pivot 82 could include a teeth locking means (not shown) to lock a desired angular position.

FIG. 8 shows yet another alternate embodiment of the present invention where a second spool 56 is mounted below the spool 22, again, to permit the towing of two skaters. The second spool 22 can be mounted in various appropriate places on the bracket 26, or another successive bracket (not shown) mounted to the seat post 40. The spool 22 in any of the embodiments described can be mounted or otherwise attached to the bicycle 28 in a variety of ways, including a simple cable tie or other means that attaches the towing device 20 to the bicycle 28 in a safe manner that does not interfere with the operation of the bicycle and provides a safe means to tow a skater 32 therebehind.

While particular forms of the invention have been illustrated and described, it will also be apparent to those skilled in the art that various modifications can be made without departing from the spirit and scope of the invention. Accordingly, it is not intended that the invention be limited except by the claims.

What is claimed is:

1. A device for towing a skater behind a bicycle, comprising:
a bracket secured to said bicycle;
a spool coupled to said bracket providing a retractive bias on a towline; and
a handle attached to a free end of said towline and configured to permit the grasping by said skater with a maximum of two fingers.

2. The device of claim 1 wherein said spool is pivotally coupled to said bracket to permit the rotation of said spool relative to said bicycle, whereby the skater may move from side to side relative the bicycle with the tow line always emanating from the spool to the skater along a straight path.

3. The device of claim 2 wherein the rotation of said spool is limited by at least one stop.

4. The device of claim 1 wherein said bracket is configured to permit adjustment of said spool relative to said bicycle whereby the height of the handle emanating on a straight line out of the spool may vary for different sized skaters.

5. The device of claim 1 wherein said bracket is configured to couple to said bicycle by one of a seat post, frame, or seat.

6. The device of claim 1 wherein a shock absorber substantially absorbs the impact of said handle against said spool during retraction.

7. The device of claim 6 wherein said shock absorber is one of an elastomeric grommet threaded on said towline or a spring threaded on said towline.

8. The device of claim 1 wherein said spool is mounted at an angle relative to horizontal to permit unhindered spooling and unspooling of said towline when grasped by said skater.

9. The device of claim 1 wherein said towline bifurcates to permit the attachment of two said handles, one on each said free end.

10. The device of claim 1 wherein mounted to said device is a second spool having a retractably biased second towline with a second handle attached to the free end of the second towline.

11. The device of claim 1 wherein incorporated thereon is one of a reflective decal, a reflective lens, or a reflective paint.

12. A device for towing a skater behind a bicycle comprising:
a spool means freely pivotally attached to said bicycle for rotation relative the skater and the automatic retraction of a towline,
said spool means adjustably pivotally coupled at an angle relative to horizontal to permit unhindered retraction and extension of said towline; and
a handle attached to a free end of said towline and configured to permit the grasping by said skater.

13. A method for skating, including the steps of:
providing a spool coupled to a bicycle for the automatic retraction of a towline and a handle attached to a free end of said towline configured to permit the grasping by a skater;
adjusting the spool appropriate for the height of the skater;
grasping said handle with a said skater's fingers;
propelling said bicycle with a cyclist;
towing said skater behind said bicycle;
the skater moving from side to side of the bicycle as the spool pivots about the bicycle; and,
releasing said handle by said skater simply letting go in the event of a hazardous occurrence.

14. The method of claim 13 wherein said towline is bifurcated to permit towing of multiple skaters.

15. The method of claim 13 further including the step of towing a second skater grasping a second handle.
